(19) United States
(12) Patent Application Publication
(10) Pub. No.: US 2025/0201854 A1
(43) Pub. Date: Jun. 19, 2025

(54) POSITIVE ELECTRODE FOR NON-AQUEOUS ELECTROLYTE SECONDARY BATTERY, NON-AQUEOUS ELECTROLYTE SECONDARY BATTERY USING SAME, BATTERY MODULE, AND BATTERY SYSTEM

(71) Applicant: SEKISUI CHEMICAL CO., LTD., Osaka (JP)

(72) Inventors: Hikaru YOSHIKAWA, Tsukuba-shi (JP); Junnosuke AKIIKE, Tsukuba-shi (JP)

(73) Assignee: SEKISUI CHEMICAL CO., LTD., Osaka (JP)

(21) Appl. No.: 18/847,349

(22) PCT Filed: Mar. 17, 2023
(86) PCT No.: PCT/JP2023/010742

§ 371 Date: Sep. 16, 2024

(30) Foreign Application Priority Data
Mar. 24, 2022 (JP) 2022-048179

(51) Int. Cl. H01M 4/62; H01M 4/02; H01M 4/136; H01M 4/58

(52) U.S. Cl. CPC H01M 4/625; H01M 4/136; H01M 4/5825; H01M 4/622; H01M 2004/021; H01M 2004/028

(57) ABSTRACT

A positive electrode for a non-aqueous electrolyte secondary battery, including a current collector and a positive electrode active material layer provided on the current collector, wherein: the positive electrode active material layer includes positive electrode active material particles and a binder; the binder has a Z-average molecular weight (Mz) of 400,000 or more and 1,400,000 or less; an amount of the binder is 0.1% by mass or more and 1.5% by mass or less with respect to a total mass of the positive electrode active material layer; and the positive electrode active material layer includes a conductive carbon in an amount of 0.5% by mass or more and less than 3.0% by mass or less with respect to a total mass of the positive electrode active material layer.

### TECHNICAL FIELD

The present invention relates to a positive electrode for non-aqueous electrolyte secondary battery, as well as a non-aqueous electrolyte secondary battery, a battery module, and a battery system, each using the positive electrode.

Priority is claimed on Japanese Patent Application No. 2022-048179, filed Mar. 24, 2022, the contents of which are incorporated herein by reference.

### BACKGROUND ART

A non-aqueous electrolyte secondary battery is generally composed of a positive electrode, a non-aqueous electrolyte, a negative electrode, and a separation membrane (hereinafter, also referred to as “separator”) installed between the positive electrode and the negative electrode.

A conventionally known positive electrode for a non-aqueous electrolyte secondary battery is formed by fixing a composition composed of a positive electrode active material containing lithium ions, a conducting agent, and a binder to the surface of a metal foil as a current collector.

Examples of the practically used positive electrode active material containing lithium ions include lithium transition metal composite oxides such as lithium cobalt oxide, lithium nickel oxide, and lithium manganese oxide, and lithium phosphate compounds such as lithium iron phosphate.

Patent Literature 1 describes that the reduction in size of active material particles and the accompanying increase in the amount of conducting agent necessitate an increase in the amount of binder in the positive electrode.

### PRIOR ART DOCUMENT

### Patent Document

Patent Document 1: Japanese Patent Granted Publication No. 5371024

### SUMMARY OF THE INVENTION

### Problems to be Solved by the Invention

In non-aqueous electrolyte secondary batteries, when the binder content is increased, the total resistance value increases, and the mass of the binder that does not contribute to the capacity increases, making it difficult to achieve high energy density and high output. In addition, Patent Literature 1 describes that in order to improve the binding of the active material, it is preferable to form a positive electrode active material layer using a modified fluoropolymer with a weight average molecular weight of 350,000 or more. On the other hand, Patent Literature 1 does not describe the state of the binder or the configuration of the positive electrode that is suitable for increasing the energy density while maintaining the durability of the non-aqueous electrolyte secondary battery. In addition, a binder with a high average molecular weight shows excellent binding performance, and even if the added amount thereof is reduced, sufficient binding force can be obtained between the current collector and the positive electrode active material layer. On the other hand, the intrinsic viscosity of the positive electrode composition containing the active material particles also increases, so that agglomeration of the active material particles and the conducting agent is likely to occur, the average pore diameter of the pores in the positive electrode active material layer becomes small, and the retention of the electrolyte becomes insufficient, resulting in a decrease in the charge and discharge performance of the non-aqueous electrolyte secondary battery.

The reduction in the particle size of the active material particles and the accompanying increase in the amount of conducting agent for the purpose of increasing the output as described above necessitate an increase in the amount of binder in the positive electrode. In addition, the reduction in the particle size of the active material particles reduces the anchoring effect of the active material particles on the current collector, that is, the effect of the active material layer being firmly fixed to the current collector by the active material particles penetrating into the minute unevenness of the current collector surface together with the binder. As a result, the binding between the active material particles and the current collector becomes more dependent on the chemical bond by the binder, and the amount of binder required increases. Even when the reaction resistance and electronic resistance are reduced by reducing the particle size of the active material and adjusting the amount of conducting agent, the increase in the amount of binder results in higher reaction resistance and higher diffusion resistance, and the total resistance value of the non-aqueous electrolyte secondary battery increases.

In addition, when a positive electrode is produced using an extremely small amount of binder, the binding force between the current collector and the positive electrode active material layer is extremely weak, and peeling between the current collector and the positive electrode active material layer occurs easily due to the impregnation with the electrolyte and the expansion and contraction of the active material particles accompanying charging and discharging. Peeling of the positive electrode active material layer from the current collector cuts off the flow of electrons, facilitating increase in electrical resistance. The use of such a positive electrode can cause a problem in that it does not satisfy the durability required for battery applications, such as automotive battery applications, that require suppressing an increase in resistance and exhibiting high input/output performance over a long period of time.

The present invention can provide a positive electrode for a non-aqueous electrolyte secondary battery, which enables production of a non-aqueous electrolyte secondary battery with sufficient binding of positive electrode active material particles, high gravimetric energy density, and excellent cycle performance.

### Means for Solving the Problems

As a result of extensive and intensive studies, the present inventors have made the following findings.

A binder with a high Z average molecular weight (Mz) shows excellent binding performance, so that even when the binder content in the positive electrode active material layer is reduced, sufficient peel strength of the positive electrode active material layer relative to the current collector can be obtained. On the other hand, when the Z average molecular weight (Mz) of the binder is high, the intrinsic viscosity of the binder also increases, so that the positive electrode active material particles and the conducting agent tend to agglomerate, the average pore diameter of the pores in the positive electrode active material layer increases, voids occur in the positive electrode active material layer, the conductive path deteriorates, and the charge/discharge performance deteriorates. In addition, the conducting agent also tends to agglomerate, and the uneven distribution of the conducting agent causes local resistance differences inside the positive electrode. As a result, during large-current charging and discharging, excessive current tends to flow through the conducting agent, which tends become a site that triggers deterioration resulting in side reactions with the electrolyte.

In the present invention, by adopting a configuration in which the positive electrode active material layer has a low amount of conducting agent or the positive electrode active material layer does not contain a conducting agent, it is possible to avoid the above-mentioned problems and provide a non-aqueous electrolyte secondary battery that has a high gravimetric energy density and excellent cycle performance.

The embodiments of the present invention are as follows.
[1] A positive electrode for a non-aqueous electrolyte secondary battery, comprising a current collector and a positive electrode active material layer provided on the current collector, wherein:
   the positive electrode active material layer comprises positive electrode active material particles and a binder,
   the binder has a Z-average molecular weight (Mz) of 400,000 or more and 1,400,000 or less, 500,000 or more and 1,200,000 or less, or 600,000 to 1,000,000,
   an amount of the binder is 0.1% by mass or more and 1.5% by mass or less, 0.3% by mass or more and 1.3% by mass or less, or 0.5% by mass or more and 1.1% by mass or less with respect to a total mass of the positive electrode active material layer, and
   the positive electrode active material layer comprises a conductive carbon, and an amount of the conductive carbon is 0.5% by mass or more and less than 3.0 by mass, 1.0 to 2.8% by mass, or 1.2 to 2.6% by mass or less with respect to a total mass of the positive electrode active material layer.
[2] The positive electrode according to [1], wherein a peel strength of the positive electrode active material layer relative to the current collector is 10 mN/cm or more and 1000 mN/cm or less, 100 mN/cm or more and 900 mN/cm or less, or 200 mN/cm or more and 800 mN/cm or less.
[3] The positive electrode according to [1] or [2], wherein the positive electrode active material layer is a porous layer,
   the positive electrode active material layer has a specific pore surface area of 5.0 m²/g or more and 10 m²/g or less, 5.5 m²/g or more and 9.5 m²/g or less, or 6.0 m²/g or more and 9.0 m²/g or less, and
   the positive electrode active material layer has an average pore diameter (D50) of 0.070 μm or more and 0.150 μm or less, 0.75 μm or more and 0.145 μm or less, or 0.80 μm or more and 0.140 μm or less.
[4] The positive electrode according to any one of [1] to [3], wherein the positive electrode active material particles comprise a compound represented by a formula LiFeₓM₍₁₋ₓ₎PO₄, wherein 0≤x≤1, M is Co, Ni, Mn, Al, Ti or Zr.
[5] The positive electrode according to any one of [1] to [4], wherein the positive electrode active material particles include a core section composed of a positive electrode active material, and a coating section including a conductive material, wherein the coating section covers a surface of the core section, and an area of the coating section accounts for 50% or more of a surface area of the core section.
[6] A non-aqueous electrolyte secondary battery, comprising the positive electrode of any one of [1] to [5], a negative electrode, and a non-aqueous electrolyte disposed between the positive electrode and the negative electrode.
[7] A battery module or battery system including a plurality of the non-aqueous electrolyte secondary batteries of [6].

### Effect of the Invention

The present invention can provide a positive electrode for a non-aqueous electrolyte secondary battery, which enables production of a non-aqueous electrolyte secondary battery with sufficient binding of positive electrode active material particles, high gravimetric energy density, and excellent cycle performance.

### BRIEF DESCRIPTION OF THE DRAWINGS

FIG. 1 is a cross-sectional view schematically showing an example of a positive electrode for a non-aqueous electrolyte secondary battery according to the present invention.

FIG. 2 is a cross-sectional view schematically showing an example of a non-aqueous electrolyte secondary battery according to the present invention.

FIG. 3 is a process diagram for explaining a method for measuring the peel strength of a positive electrode active material layer.

### EMBODIMENTS TO CARRY OUT THE INVENTION

In the present specification and claims, “to” indicating a numerical range means that the numerical values described before and after “to” are included as the lower limit and the upper limit of the range.

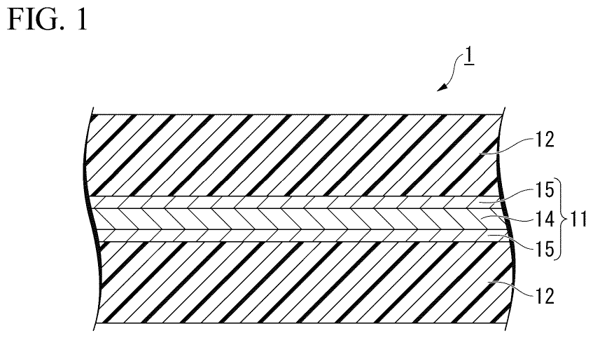

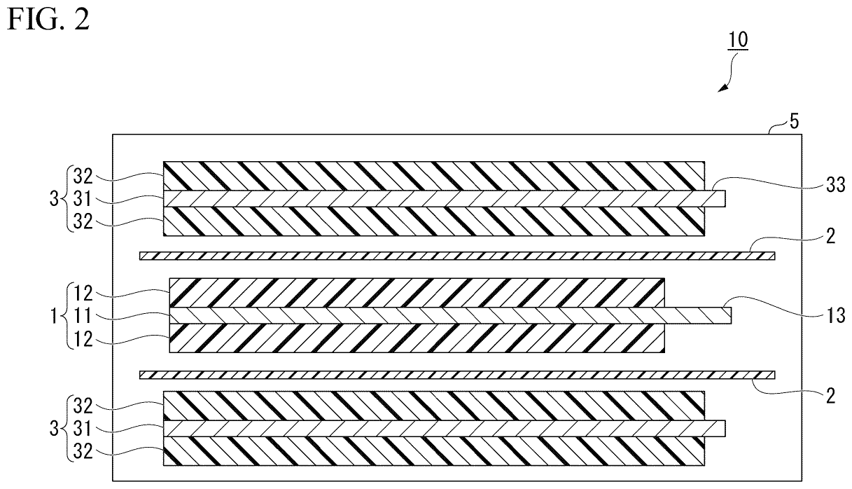

FIG. 1 is a schematic cross-sectional view showing one embodiment of the positive electrode of the present invention for a non-aqueous electrolyte secondary battery, and FIG. 2 is a schematic cross-sectional view showing one embodiment of the non-aqueous electrolyte secondary battery of the present invention.

FIG. 1 and FIG. 2 are schematic diagrams for facilitating the understanding of the configurations, and the dimensional ratios and the like of each component do not necessarily represent the actual ones.

### <Positive Electrode for Non-Aqueous Electrolyte Secondary Battery>

In the present embodiment, the positive electrode for a non-aqueous electrolyte secondary battery (also simply referred to as “positive electrode”) 1 has a positive electrode current collector 11 and a positive electrode active material layer 12.

The positive electrode active material layer 12 is present on at least one surface of the positive electrode current collector 11. The positive electrode active material layers 12 may be present on both sides of the positive electrode current collector 11.

In the example shown in FIG. 1, the positive electrode current collector 11 has current collector coating layers 15 on its surfaces facing the positive electrode active material layers 12. That is, the positive electrode current collector 11 has a positive electrode current collector main body 14 and current collector coating layers 15 that cover the positive electrode current collector main body 14 on its surfaces facing the positive electrode active material layers 12. The positive electrode current collector main body 14 alone may be used as the positive electrode current collector 11.

### [Positive Electrode Active Material Layer]

The positive electrode active material layer 12 includes positive electrode active material particles.

The positive electrode active material layer 12 further includes a binder.

The positive electrode active material layer 12 may further include a conducting agent. In the context of the present specification, the term “conducting agent” refers to a conductive material of a particulate shape, a fibrous shape, etc., which is mixed with the positive electrode active material for the preparation of the positive electrode active material layer or formed in the positive electrode active material layer, and is caused to be present in the positive electrode active material layer in a form connecting the particles of the positive electrode active material.

The positive electrode active material layer 12 may further include a dispersant.

The amount of the positive electrode active material particles is preferably 80.0 to 99.9% by mass, and more preferably 90 to 99.5% by mass, based on the total mass of the positive electrode active material layer 12.

The thickness of the positive electrode active material layer is preferably 30 to 500 μm, more preferably 40 to 400 μm, particularly preferably 50 to 300 μm. When the thickness of the positive electrode active material layer is not less than the lower limit value of the above range, the energy density of a battery with the positive electrode incorporated therein tends to improve. When the thickness is not more than the upper limit value of the above range, the peel strength of the positive electrode active material layer can be improved, thereby preventing delamination of the positive electrode active material layer during charging/discharging. When the positive electrode active material layers are present on both sides of the positive electrode current collector, the thickness of the positive electrode active material layer is the total thickness of the two layers located on both sides.

The peel strength of the positive electrode active material layer 12 relative to the positive electrode collector 11 is preferably 10 mN/cm or more and 1000 mN/cm or less, more preferably 100 mN/cm or more and 900 mN/cm or less, particularly preferably 200 mN/cm or more and 800 mN/cm or less. When the peel strength of the positive electrode active material layer 12 is not less than the lower limit value described above, the positive electrode active material layer 12 is less likely to be peeled off from the positive electrode collector 11 even after repeated charging and discharging. When the peel strength of the positive electrode active material layer 12 is not more than the upper limit value described above, the binder content is appropriate, and the gravimetric energy density of the battery can be increased.

The peel strength of the positive electrode active material layer 12 relative to the positive electrode collector 11 is a 180° peel strength determined by the measurement method described in the Examples below.

The positive electrode active material layer 12 is a porous layer and has a large number of pores. The positive electrode active material layer 12 preferably has a pore specific surface area of 5.0 m²/g or more and 10 m²/g or less, more preferably 5.5 m²/g or more and 9.5 m²/g or less, particularly preferably 6.0 m²/g or more and 9.0 m²/g or less. When the pore specific surface area of the positive electrode active material layer 12 is not less than the lower limit value of the above range, a sufficient area for reaction with the electrolyte is secured, thereby improving cycle performance and providing particularly high effect in rapid charge/discharge cycles. When the pore specific surface area of the positive electrode active material layer 12 is not more than the upper limit value of the above range, the amounts of small-sized active material particles with high reactivity and the conducting agent are small, thereby suppressing side reactions with the electrolyte and providing particularly high effect in rapid charge/discharge cycles at large currents.

### <<Method of Pore Specific Surface Area Measurement>>

In the context of the present specification, the pore specific surface area of the positive electrode active material layer 12 can be measured by a known gas adsorption method or mercury porosimetry.

The average pore diameter of the pores in the positive electrode active material layer 12 is preferably 0.070 μm or more and 0.150 μm or less, more preferably 0.75 μm or more and 0.145 μm or less, particularly preferably 0.80 μm or more and 0.140 μm or less. The average pore diameter in this context is the pore diameter at which the cumulative pore volume is 50% of the total pore volume in the pore diameter range of 0.003 to 1.003 to 1.000 μm in the pore diameter distribution measured by the method described below. That is, the average pore diameter is the so-called median pore diameter, and hereinafter also referred to as “average pore diameter (D50)”.

When the average pore diameter (D50) of the pores in the positive electrode active material layer 12 is not less than the lower limit value of the above range, the volume available for holding sufficient electrolyte is secured, thereby improving the charge/discharge cycle performance, and providing the effect of allowing the lithium ions in the electrolyte to move rapidly particularly when a rapid charge/discharge cycle is performed. When the average pore diameter (D50) of the pores in the positive electrode active material layer 12 is not more than the upper limit value of the above range, the distance between adjacent particles is not too far and a good conductive path is created, thereby improving the charge/discharge cycle performance and increasing electronic conduction especially when a rapid charge/discharge cycle is performed, so that side reactions can be suppressed during charging and discharging at a large current, resulting in a higher effect.

The porous layer means, for example, a positive electrode active material layer having a pore specific surface area of 5.0 m²/g or more. In the context of the present specification, the pore specific surface area of the positive electrode active material layer 12 can be measured by a known gas adsorption method or mercury porosimetry. Specifically, the pore size distribution of the positive electrode active material layer is measured by the method described in the Examples below, and the pore specific surface area can be calculated based on the obtained pore size distribution.

### <<Method for Measuring Average Pore Diameter (D50) of Pores>>

In the context of the present specification, the average pore diameter (D50) of pores in the positive electrode active material layer 12 can be measured by a known gas adsorption method or mercury porosimetry. Details of the measurement method are described in the Examples section.

### [Positive Electrode Active Material Particles]

The positive electrode active material particles include a positive electrode active material. At least a part of the positive electrode active material particles is a coated particle.

In the coated particles, a coating section containing a conductive material (hereinafter, also referred to as “active material coating section”) is present on the surfaces of the positive electrode active material particles. The active material coating section of the active material particles enables the positive electrode active material particles to further enhance the battery capacity and cycling performance.

For example, the active material coating section is formed in advance on the surface of the positive electrode active material particles, and is present on the surface of the positive electrode active material particles in the positive electrode active material layer. That is, the active material coating section in the present embodiment is not one newly formed in the steps following the preparation step of a positive electrode composition. In addition, the active material coating section is not one that comes off in the steps following the preparation step of a positive electrode composition. For example, the active material coating section stays on the surface of the positive electrode active material even when the coated particles are mixed with a solvent by a mixer or the like during the preparation of a positive electrode composition. Further, the active material coating section stays on the surface of the positive electrode active material even when the positive electrode active material layer is detached from the positive electrode and then put into a solvent to dissolve the binder contained in the positive electrode active material layer in the solvent. Furthermore, the active material coating section stays on the surface of the positive electrode active material even when an operation to disintegrate agglomerated particles is implemented for measuring the particle size distribution of the particles in the positive electrode active material layer by the laser diffraction scattering method.

The active material coating section of the active material particles preferably covers 50% or more, preferably 70% or more, and more preferably 90% or more of the total area of the entire outer surfaces of the positive electrode active material particles. That is, the coated particles have a core section that is a positive electrode active material and an active material coating section that covers the surface of the core section, and the area ratio (i.e., coverage) of the active material coating section with respect to the surface area of the core section is preferably 50% or more, more preferably 70% or more, and even more preferably 90% or more. The upper limit of the coverage is not particularly limited, but for example, preferably 94% or less, more preferably 97% or less, even more preferably 100% or less. The coverage is preferably 50 to 94%, more preferably 70 to 97%, even more preferably 90 to 100%.

Examples of the method for producing the coated particles include a sintering method and a vapor deposition method.

Examples of the sintering method include a method that sinters an active material composition containing the positive electrode active material particles and an organic substance at 500 to 1000° C. for 1 to 100 hours under atmospheric pressure. Examples of the organic substance added to the active material composition include salicylic acid, catechol, hydroquinone, resorcinol, pyrogallol, fluoroglucinol, hexahydroxybenzene, benzoic acid, phthalic acid, terephthalic acid, phenylalanine, water dispersible phenolic resins, sucrose, glucose, lactose, malic acid, citric acid, allyl alcohol, propargyl alcohol, ascorbic acid, and polyvinyl alcohol. With respect to these substances, a mixture of two or more kinds may be used, and an organic substance other than those listed above may also be used. This sintering method sinters an active material composition to allow carbon in the organic material to be fused to the surface of the positive electrode active material to thereby form the active material coating section.

Another example of the sintering method is the so-called impact sintering coating method.

The impact sintering coating method is carried out, for example, as follows. In an impact sintering coating device, a burner is ignited using a mixture of hydrocarbon fuel and oxygen, and a flame is generated by burning the mixture in a combustion chamber. In this process, the amount of oxygen is reduced to an amount equivalent to complete combustion of the fuel or less to lower the flame temperature. A powder supply nozzle is installed behind the flame, and a solid-liquid-gas three-phase mixture consisting of a slurry obtained by dissolving an organic matter for coating using a solvent, and a combustion gas is sprayed from the powder supply nozzle. By increasing the amount of combustion gas maintained at room temperature, the temperature of the sprayed fine powder is lowered, and the sprayed fine powder is accelerated at a temperature below the transformation temperature, sublimation temperature or evaporation temperature of the powder material, and is instantly sintered by impact to coat the particles of the positive electrode active material.

Examples of the vapor deposition method include a vapor phase deposition method such as a physical vapor deposition method and a chemical vapor deposition method, and a liquid phase deposition method such as plating.

The coverage can be measured by a method as follows. First, the particles in the positive electrode active material layer are analyzed by the energy dispersive X-ray spectroscopy using a transmission electron microscope (TEM-EDX). Specifically, an elemental analysis is performed by EDX with respect to the outer peripheral portion of the positive electrode active material particles in a TEM image. The elemental analysis is performed on carbon to identify the carbon covering the positive electrode active material particles. A section with a carbon coating having a thickness of 1 nm or more is defined as a coating section, and the ratio of the coating section to the entire circumference of the observed positive electrode active material particle can be determined as the coverage. The measurement can be performed with respect to, for example, 10 positive electrode active material particles, and an average value thereof can be used as a value of the coverage.

Further, the active material coating section is a layer directly formed on the surface of particles (core section) composed of only the positive electrode active material, which has a thickness of 1 nm to 100 nm, preferably 5 nm to 50 nm. This thickness can be determined by the above-mentioned TEM-EDX used for the measurement of the coverage.

With respect to the coverage of the positive electrode active material particles, the determination can also be implemented by calculation from TEM-EDX elemental mapping of particles with elements specific to the positive electrode active material and elements specific to the conductive material in the active material coating section of the active material. Similarly, a ratio of the active material coating section to the entire circumference of the observed positive electrode active material particle may be determined as the coverage, with the coating being defined as at least 1 nm-thick portion of the element specific to the conductive material. The measurement can be performed with respect to, for example, 10 positive electrode active material particles, and an average value thereof can be used as a value of the coverage.

In the present embodiment, the area ratio of the active material coating section in the coated particles is particularly preferably 100% with respect to the surface area of the core section.

This ratio is an average value for all the positive electrode active material particles present in the positive electrode active material layer. As long as this average value is not less than the above lower limit value, the positive electrode active material layer may contain positive electrode active material particles without the active material coating section. When the positive electrode active material particles (hereinafter, also referred to as “single particles”) without the active material coating section are present in the positive electrode active material layer, the amount thereof is preferably 30% by mass or less, more preferably 20% by mass or less, and particularly preferably 10% by mass or less, with respect to the total mass of the positive electrode active material particles present in the positive electrode active material layer. When single particles are present in the positive electrode active material layer, the lower limit of the amount of single particles relative to the total amount of positive electrode active material particles is not particularly limited, but may be 0.1% by mass or more, 0.2% by mass or more, or 0.3% by mass or more. When single particles are present in the positive electrode active material layer, the amount of single particles relative to the total amount of positive electrode active material particles is preferably 0.3 to 30% by mass, more preferably 0.2 to 20% by mass, even more preferably 0.1 to 10% by mass. In the present embodiment, it is preferred that single particles are not present in the positive electrode active material layer.

The conductive material of the active material coating section preferably contains carbon (i.e., conductive carbon). The conductive material may be composed only of carbon, or may be a conductive organic compound containing carbon and elements other than carbon.

Examples of the other elements include nitrogen, hydrogen, oxygen and the like. In the conductive organic compound, the amount of the other elements is preferably 10 atomic % or less, and more preferably 5 atomic % or less.

It is more preferable that the conductive material in the active material coating section is composed only of carbon.

The amount of the conductive material is 0.1 to 4.0% by mass, more preferably 0.5 to 3.0% by mass, and even more preferably 0.7 to 2.5% by mass, based on total mass of the positive electrode active material particles having the active material coating section. Excessive amount of the conductive material is not favorable in that the conductive material may come off the surface of the positive electrode active material particles and remain as isolated conducting agent particles.

Conductive particles that do not contribute to the creation of conductive path may become a site where self-discharge of the battery starts or a cause of undesirable side reactions.

The positive electrode active material preferably contains a compound having an olivine crystal structure.

The compound having an olivine crystal structure is preferably a compound represented by the following formula: LiFeₓM₍₁₋ₓ₎PO₄ (hereinafter, also referred to as “formula (I)”). In the formula (I), 0≤x≤1. M is Co, Ni, Mn, Al, Ti or Zr. A minute amount of Fe and M (Co, Ni, Mn, Al, Ti or Zr) may be replaced with another element so long as the replacement does not affect the physical properties of the compound. The presence of a trace amount of metal impurities in the compound represented by the formula (I) does not impair the effect of the present invention.

The compound represented by the formula (I) is preferably lithium iron phosphate represented by LiFePO₄ (hereinafter, also referred to as “lithium iron phosphate”).

The positive electrode active material particles are more preferably lithium iron phosphate particles having, on at least a part of their surfaces, an active material coating section including a conductive material (hereinafter, also referred to as “coated lithium iron phosphate particles”). It is more preferable that the entire surface of lithium iron phosphate particles is coated with a conductive material for achieving more excellent battery capacity and cycling performance.

The coated lithium iron phosphate particles can be produced by a known method.

For example, the coated lithium iron phosphate particles can be obtained by a method in which a lithium iron phosphate powder is prepared by following the procedure described in Japanese Patent No. 5098146, and at least a part of the surface of lithium iron phosphate particles in the powder is coated with carbon by following the procedure described in GS Yuasa Technical Report, June 2008, Vol. 5, No. 1, pp. 27-31 and the like.

Specifically, first, iron oxalate dihydrate, ammonium dihydrogen phosphate, and lithium carbonate are weighed to give a specific molar ratio, and these are pulverized and mixed in an inert atmosphere. Next, the obtained mixture is heat-treated in a nitrogen atmosphere to prepare a lithium iron phosphate powder. Then, the lithium iron phosphate powder is placed in a rotary kiln and heat-treated while supplying methanol vapor with nitrogen as a carrier gas to obtain a powder of lithium iron phosphate particles having at least a part of their surfaces coated with carbon.

For example, the particle size of the lithium iron phosphate powder can be adjusted by optimizing the crushing time in the crushing process. The amount of carbon coating the particles of the lithium iron phosphate powder can be adjusted by optimizing the heating time and temperature in the step of implementing heat treatment while supplying methanol vapor. It is desirable to remove the carbon particles not consumed for coating by subsequent steps such as classification and washing.

The positive electrode active material particles may include at least one type of other positive electrode active material particles including other positive electrode active materials than the compound having an olivine type crystal structure.

Preferable examples of the other positive electrode active materials include a lithium transition metal composite oxide. Specific examples thereof include lithium cobalt oxide, lithium nickel oxide, lithium nickel cobalt aluminum oxide (LiNixCo_{y}Alzₒ2 with the proviso that x+y+z=1), lithium nickel cobalt manganese oxide (LiNiₓCoy_{Mn}zO₂ with the proviso that x+y+z=1), lithium manganese oxide, lithium manganese cobalt oxide, lithium manganese chromium oxide, lithium vanadium nickel oxide, nickel-substituted lithium manganese oxide (e.g., LiMn_{1.5}Ni_{0.5}O₄), and lithium vanadium cobalt oxide, as well as nonstoichiometric compounds formed by partially substituting the compounds listed above with metal elements. Examples of the metal element include one or more selected from the group consisting of Mn, Mg, Ni, Co, Cu, Zn and Ge.

The other positive electrode active particles material may have, on at least a part of surfaces thereof, the active material coating section described above.

The amount of the compound having an olivine type crystal structure is preferably 50% by mass or more, preferably 80% by mass or more, and even more preferably 90% by mass or more, based on the total mass of the positive electrode active material. This amount may be 100% by mass. The amount of the compound having an olivine type crystal structure is preferably 50 to 100% by mass or more, preferably 80 to 100% by mass or more, and even more preferably 90 to 100% by mass or more, based on the total mass of the positive electrode active material. When the positive electrode active material particles have the coated section, the total mass of the positive electrode active material particles includes the mass of the coated section.

When the coated lithium iron phosphate particles are used, the amount of the coated lithium iron phosphate particles is preferably 50% by mass or more, more preferably 80% by mass or more, and even more preferably 90% by mass or more, based on the total mass of the positive electrode active material particles. This amount may be 100% by mass. When the coated lithium iron phosphate particles are used, the amount of the coated lithium iron phosphate particles is preferably 50 to 100% by mass or more, more preferably 80 to 100% by mass or more, and even more preferably 90 to 100% by mass or more, based on the total mass of the positive electrode active material particles.

The thickness of the active material coating section of the positive electrode active material particles is preferably 1 to 100 nm.

The thickness of the active material coating section of the positive electrode active material particles can be measured by a method of measuring the thickness of the active material coating section in a transmission electron microscope (TEM) image of the positive electrode active material particles. The thickness of the active material coating sections on the surfaces of the positive electrode active material particles need not be uniform. It is preferable that the positive electrode active material particles have, on at least a part of surfaces thereof, the active material coating section having a thickness of 1 nm or more, and the maximum thickness of the coated section is 100 nm or less.

The average particle size of the positive electrode active material particles is preferably 0.1 to 20.0 μm, and more preferably 0.5 to 15.0 μm. When two or more types of positive electrode active materials are used, the average particle size of each of such positive electrode active materials may be within the above range. When the positive electrode active material particles have the active material coating section, the average particle size of the positive electrode active material particles includes the thickness of the coated section.

When the average particle size is not less than the lower limit value of the above range, the specific surface area (unit: m²/g) becomes appropriately large, and it becomes easier to secure an area for reaction during charging and discharging. As a result, the resistance of the battery decreases and the rapid charging performance is less likely to deteriorate. On the other hand, when the average particle size is not more than the upper limit value of the above range, the specific surface area becomes appropriately small, which tends to improve dispersibility in the positive electrode composition and suppress generation of agglomerates. As a result, the conductive paths between particles become uniform inside the positive electrode active material layer 12, so that the rapid charging performance is likely to improve.

The average particle size of the positive electrode active material particles in the present specification is a volume-based median particle size measured using a laser diffraction/scattering particle size distribution analyzer.

### [Binder]

The binder that can be contained in the positive electrode active material layer 12 is an organic substance, and examples thereof include polyacrylic acid, lithium polyacrylate, polyvinylidene fluoride, polyvinylidene fluoride-hexafluoropropylene copolymers, styrene butadiene rubbers, polyvinyl alcohol, polyvinyl acetal, polyethylene oxide, polyethylene glycol, carboxymethyl cellulose, polyacrylic nitrile, and polyimide. With respect to the binder, a single type thereof may be used alone or two or more types thereof may be used in combination.

The Z-average molecular weight (Mz) of the binder is 400,000 or more and 1,400,000 or less, preferably 500,000 or more and 1,200,000 or less, even more preferably 600,000 to 1,000,000. When the Z average molecular weight (Mz) of the binder is not less than the lower limit value described above, the binder shows excellent binding performance, and even when the binder content in the positive electrode active material layer 12 is reduced, sufficient peel strength of the positive electrode active material layer 12 relative to the positive electrode current collector 11 can be obtained. When the Z average molecular weight (Mz) of the binder is not more than the upper limit value described above, unintended agglomeration of the active material and conducting agent due to excessively strong binding can be avoided, and a good conductive path can be formed in the positive electrode active material layer 12, thereby improving the rapid charge/discharge cycle performance.

The Z average molecular weight (Mz) of the binder can be measured by a measurement method using gel permeation chromatography.

The lower the binder content in the positive electrode active material layer 12, the higher the gravimetric energy density (Wh/kg) of the battery.

The binder content relative to the total mass of the positive electrode active material layer 12 is preferably 0.1% by mass or more and 1.5% by mass or less, preferably 0.3% by mass or more and 1.3% by mass or less, more preferably 0.5% by mass or more and 1.1% by mass or less. When the binder content is not less than the lower limit value described above, sufficient peel strength is obtained between the positive electrode active material layer 12 and the positive electrode current collector 11. When the binder content is not more than the upper limit value described above, the Gravimetric energy density (Wh/kg) of the battery increases.

### [Conducting Agent]

Examples of the conducting agent contained in the positive electrode active material layer 12 include carbon materials such as graphite, graphene, hard carbon, Ketjen black, acetylene black, and carbon nanotube. With respect to the conducting agent, a single type thereof may be used alone or two or more types thereof may be used in combination.

The amount of the conducting agent in the positive electrode active material layer 12 is, for example, preferably 4 parts by mass or less, more preferably 3 parts by mass or less, and even more preferably 1 part by mass or less, relative to 100 parts by mass of the positive electrode active material. It is particularly preferable that the positive electrode active material layer does not contain a conducting agent, and it is desirable that there are no isolated conducting agent particles that do not contribute to the creation of conductive path in the positive electrode active material layer.

Conducting agent particles that do not contribute to the creation of conductive path may become a site where self-discharge of the battery starts or a cause of undesirable side reactions.

When the conducting agent is incorporated into the positive electrode active material layer 12, the lower limit value of the amount of the conducting agent is appropriately determined according to the type of the conducting agent, and is, for example, more than 0.1% by mass, based on the total mass of the positive electrode active material layer 12. When a conducting agent is incorporated into the positive electrode active material layer 12, the amount of the conducting agent is preferably more than 0.1% by mass and 2.5% by mass or less, more preferably 0.1% by mass and 2.3% by mass or less, even more preferably 0.1% by mass and 2.0% by mass or less, based on the total mass of the positive electrode active material layer 12. In the context of the present specification, the expression “the positive electrode active material layer 12 does not contain a conducting agent” or similar expression means that the positive electrode active material layer 12 does not substantially contain a conducting agent, and should not be construed as excluding a case where a conducting agent is contained in such an amount that the effects of the present invention are not affected. For example, if the amount of the conducting agent is 0.1% by mass or less, based on the total mass of the positive electrode active material layer, then, it is judged that substantially no conducting agent is contained.

### [Dispersant]

The dispersant contained in the positive electrode active material layer 12 is an organic substance, and examples thereof include polyvinylpyrrolidone, polyvinyl alcohol, polyvinyl butyral, and polyvinylformal. With respect to these dispersants, a single type thereof may be used individually or two or more types thereof may be used in combination.

The dispersant prevents the particles in the positive electrode active material layer 12 from agglomerating, and contributes to the creation of a good conductive path. On the other hand, when the dispersant content is too high, the resistance increases and the input performance tends to deteriorate.

The amount of the dispersant is preferably 0.5% by mass or less, more preferably 0.2% by mass or less, based on the total mass of the positive electrode active material layer 12.

When the positive electrode active material layer 12 contains a dispersant, the lower limit of the amount of the dispersant is preferably 0.01% by mass or more, more preferably 0.05% by mass or more, based on the total mass of the positive electrode active material layer 12. When the positive electrode active material layer contains a dispersant, the amount of the dispersant is preferably 0.01 to 0.5% by mass, more preferably 0.05 to 0.2% by mass or more.

### [Positive Electrode Current Collector Main Body]

The positive electrode current collector body 14 is formed of a metal material. Examples of the metal material include conductive metals such as copper, aluminum, titanium, nickel, and stainless steel.

The thickness of the positive electrode current collector main body 14 is preferably, for example, 8 to 40 μm, and more preferably 10 to 25 μm.

The thickness of the positive electrode current collector main body 14 and the thickness of the positive electrode current collector 11 can be measured using a micrometer. One example of the measuring instrument usable for this purpose is an instrument with the product name “MDH-25M”, manufactured by Mitutoyo Co., Ltd.

### [Current Collector Coating Layer]

It is preferable that the positive electrode current collector main body 14 has, on at least a part of its surface, a current collector coating layer 15. The current collector coating layer 15 contains a conductive material.

In this context, the expression “at least a part of its surface” means 10 to 100%, preferably 30 to 100%, more preferably 50 to 100% of the area of the surface of the positive electrode current collector main body 14.

The conductive material in the current collector coating layer 15 preferably contains carbon (conductive carbon). The conductive material is more preferably one composed only of carbon.

The current collector coating layer 15 is preferred to be, for example, a coating layer containing carbon particles such as carbon black and a binder. Examples of the binder for the current collector coating layer 15 include those listed above as examples of the binder for the positive electrode active material layer 12.

With regard to the production of the positive electrode current collector 11 in which the surface of the positive electrode current collector main body 14 is coated with the current collector coating layer 15, for example, the production can be implemented by a method in which a composition (i.e., composition for preparing the current collector coating layer) containing the conductive material, the binder, and a solvent is applied to the surface of the positive electrode current collector main body 14 with a known coating method such as a gravure method, followed by drying to remove the solvent.

The thickness of the current collector coating layer 15 is preferably 0.1 to 4.0 μm.

The thickness of the current collector coating layer 15 can be measured by a method that measures the thickness of the coating layer in a transmission electron microscope (TEM) image or a scanning electron microscope (SEM) image of a cross section of the current collector coating layer 15. The thickness of the current collector coating layer need not be uniform. It is preferable that the current collector coating layer 15 having a thickness of 0.1 μm or more is present on at least a part of the surface of the positive electrode current collector main body 14, and the maximum thickness of the current collector coating layer 15 is 4.0 μm or less.

### [Conductive Carbon Content]

In the present embodiment, the positive electrode active material layer 12 contains conductive carbon. Examples of the embodiment in which the positive electrode active material layer contains the conductive carbon include the following embodiments 1 to 3.

Embodiment 1: The positive electrode active material layer contains a conducting agent; and the conducting agent includes conductive carbon.

Embodiment 2: The positive electrode active material layer contains a conducting agent; the positive electrode active material particles have, on at least a part of surfaces thereof, an active material coating section containing a conductive material; and one or both of the conductive material in the active material coating section and the conducting agent includes conductive carbon.

Embodiment 3: The positive electrode active material layer does not contain a conducting agent; the positive electrode active material particles have, on at least a part of surfaces thereof, an active material coating section containing a conductive material; and the conductive material in the active material coating section includes conductive carbon.

Embodiment 3 is more preferable in terms of increasing the mass ratio of the positive electrode active material in the positive electrode active material layer and increasing the gravimetric energy density of the battery.

The amount of the conductive carbon is preferably 0.5% by mass or more and less than 3.0 by mass, preferably 1.0 to 2.8% by mass, more preferably 1.2 to 2.6% by mass, based on the total mass of the positive electrode active material layer 12.

When the amount of the conductive carbon in the positive electrode active material layer 12 is not less than the lower limit value of the above range, the amount is sufficient to form a conductive path in the positive electrode active material layer 12. When the amount is not more than the upper limit value described above, the dispersibility improves.

The amount of the conductive carbon relative to the total mass of the positive electrode active material layer can be calculated from the conductive carbon contents of the positive electrode active material particles and the conducting agent as well as the blended amount.

The conductive carbon content based the total mass of the positive electrode active material layer can be measured by <<Method for measuring conductive carbon content>> described below with respect to a dried product, as a measurement target, obtained by vacuum-drying, at 120° C., the positive electrode active material layer detached from the positive electrode.

For example, the measurement target may be one obtained by detaching the outermost surface of the positive electrode active material layer 12 with a depth of several μm using a spatula or the like, and vacuum drying the resulting powder in an environment of 120° C.

The conductive carbon to be measured by the <<Method for measuring conductive carbon content>> described below includes carbon in the active material coating section, and carbon in the conducting agent. Carbon in the binder is not included in the conductive carbon to be measured. Carbon in the dispersant is not included in the conductive carbon to be measured.

### <<Method for Measuring Conductive Carbon Content>>

### [Measurement Method A]

A sample having a weight w1 is taken from a homogeneously mixed product of the measurement target, and the sample is subjected to thermogravimetry differential thermal analysis (TG-DTA) implemented by following step A1 defined below, to obtain a TG curve. From the obtained TG curve, the following first weight loss amount M1 (unit: % by mass) and second weight loss amount M2 (unit: % by mass) are obtained. By subtracting M1 from M2, the conductive carbon content (unit: % by mass) is obtained.

Step A1: The temperature of the sample is raised from 30° C. to 600° C. at a heating rate of 10° C./min and the temperature is held at 600° C. for 10 minutes in an argon gas stream of 300 mL/min to measure a resulting mass w2 of the sample, from which a first weight loss amount M1 is determined by formula (a1):

$$M 1 = ( w 1 - w 2 ) / w 1 \times 100 \qquad ( a1 )$$

Step A2: Immediately after the step A1, the temperature is lowered from 600° C. to 200° C. at a cooling rate of 10° C./min and held at 200° C. for 10 minutes, followed by completely substituting the argon gas stream with an oxygen gas stream. The temperature is raised from 200° C. to 1000° C. at a heating rate of 10° C./min and held at 1000° C. for 10 minutes in an oxygen gas stream of 100 mL/min to measure a resulting mass w3 of the sample, from which a second weight loss amount M2 (unit: % by mass) is calculated by formula (a2):

$$M 2 = ( w 1 - w 3 ) / w 1 \times 100 \qquad ( a2 )$$

### [Measurement Method B]

0.0001 mg of a precisely weighed sample is taken from a homogeneously mixed product of the measurement target, and the sample is burnt under burning conditions defined below to measure an amount of generated carbon dioxide by a CHN elemental analyzer, from which a total carbon content M3 (unit: % by mass) of the sample is determined. Also, a first weight loss amount M1 is determined following the procedure of the step A1 of the measurement method A. By subtracting M1 from M3, the conductive carbon content (unit: % by mass) is obtained.

### [Burning Conditions]

Temperature of combustion furnace: 1150° C.
Temperature of reduction furnace: 850° C.
Helium flow rate: 200 mL/min.
Oxygen flow rate: 25 to 30 mL/min.

### [Measurement Method C]

The total carbon content M3 (unit: % by mass) of the sample is measured in the same manner as in the above measurement method B. Further, the carbon amount M4 (unit: % by mass) of carbon derived from the binder is determined by the following method. M4 is subtracted from M3 to determine a conductive carbon content (unit: % by mass).

When the binder is polyvinylidene fluoride (PVDF: monomer (CH2_{CF}2), molecular weight 64), the conductive carbon content can be calculated by the following formula from the fluoride ion (F.) content (unit: % by mass) measured by combustion ion chromatography based on the tube combustion method, the atomic weight (19) of fluorine in the monomers constituting PVDF, and the atomic weight (12) of carbon in the PVDF.

$$PVDF content ( unit : \% by mass ) = fluoride ion content ( unit : \% by mass ) \times 64 / 38$$

$$PVDF - derived carbon amount M 4 ( unit : \% by mass ) = fluoride ion content ( unit : \% by mass ) \times 12 / 19$$

The presence of polyvinylidene fluoride as a binder can be verified by a method in which a sample or a liquid obtained by extracting a sample with an N,N-dimethylformamide solvent is subjected to Fourier transform infrared spectroscopy to confirm the absorption attributable to the C—F bond. Such verification can be likewise implemented by nuclear magnetic resonance spectroscopy (¹⁹F-NMR).

When the binder is identified as being other than PVDF, the carbon amount M4 attributable to the binder can be calculated by determining the amount (unit: % by mass) of the binder from the measured molecular weight, and the carbon content (unit: % by mass).

When the dispersant is contained, the conductive carbon content (unit: % by mass) can be obtained by subtracting M4 from M3, and further subtracting therefrom the amount of carbon belonging to the dispersant.

These methods are described in the following publications:
Toray Research Center, The TRC News No. 117 (September 2013), pp. 34-37, [Searched on Feb. 10, 2021], Internet <https://www.toray-research.co.jp/technical-info/trcnews/pdf/TRC117 (34-37).pdf>
TOSOH Analysis and Research Center Co., Ltd., Technical Report No. T1019 2017.09.20, [Searched on Feb. 10, 2021], Internet <http://www.tosoh-arc.co.jp/techrepo/files/tarc00522/T1719N.pdf>

### <<Analytical Method for Conductive Carbon>>

The conductive carbon in the coating section of the positive electrode active material and the conductive carbon as the conducting agent can be distinguished by the following analytical method.

For example, particles in the positive electrode active material layer are analyzed by a combination of transmission electron microscopy-electron energy loss spectroscopy (TEM-EELS), and particles having a carbon-derived peak around 290 eV only near the particle surface can be judged to be the positive electrode active material. On the other hand, particles having a carbon-derived peak inside the particles can be judged to be the conducting agent. In this context, “near the particle surface” means a region to the depth of 100 nm from the particle surface, while “inside” means an inner region positioned deeper than the “near the particle surface”.

As another method, the particles in the positive electrode active material layer are analyzed by Raman spectroscopy mapping, and particles showing carbon-derived G-band and D-band as well as a peak of the positive electrode active material-derived oxide crystals can be judged to be the positive electrode active material. On the other hand, particles showing only G-band and D-band can be judged to be the conducting agent.

As still another method, a cross section of the positive electrode active material layer is observed with scanning spread resistance microscope (SSRM). When the particle surface has a region with lower resistance than the inside of the particle, the region with lower resistance can be judged to be the conductive carbon present in the coated section of the active material. Other particles that are present isolatedly and have low resistance can be judged to be the conducting agent.

In this context, a trace amount of carbon considered to be an impurity and a trace amount of carbon unintentionally detached from the surface of the positive electrode active material during production are not judged to be the conducting agent.

Using any of these methods, it is possible to verify whether or not the conducting agent formed of carbon material is contained in the positive electrode active material layer.

### [Volume Density of Positive Electrode Active Material Layer]<

In the present embodiment, the volume density of the positive electrode active material layer 12 is preferably 2.10 to 2.70 g/cm³, more preferably 2.25 to 2.50 g/cm³.

The volume density of the positive electrode active material layer 12 can be measured by, for example, the following measuring method.

The thicknesses of the positive electrode 1 and the positive electrode current collector 11 are each measured with a micrometer, and the difference between these two thickness values is calculated as the thickness of the positive electrode active material layer 12. With respect to the thickness of the positive electrode 1 and the thickness of the positive electrode current collector 11, each of these thickness values is an average value of the thickness values measured at five or more arbitrarily chosen points. The thickness of the positive electrode current collector 11 may be measured at the exposed section 13 of the positive electrode current collector, which is described below.

The mass of the measurement sample punched out from the positive electrode 1 so as to have a predetermined area is measured, from which the mass of the positive electrode current collector 11 measured in advance is subtracted to calculate the mass of the positive electrode active material layer 12.

The volume density of the positive electrode active material layer 12 is calculated by the following formula (1).

$$Volume density ( unit : g / {cm}^{3} ) = mass of positive electrode active material layer ( unit : g \text{)/[} ( thickness of positive electrode active material layer ( unit : cm ) ) \times area of measurement sample ( unit : {cm}^{2} ) ] \qquad ( 1 )$$

When the volume density of the positive electrode active material layer 12 is not less than the lower limit value of the above range, the resulting non-aqueous electrolyte secondary battery is likely to show excellent input performance. When the volume density is not more than the upper limit value described above, cracks due to press load are unlikely to occur in the positive electrode active material layer 12, so that an excellent conductive path can be formed.

The volume density of the positive electrode active material layer 12 can be controlled by, for example, adjusting the amount of the positive electrode active material, the particle size of the positive electrode active material, the thickness of the positive electrode active material layer 12, and the like. When the positive electrode active material layer 12 contains a conducting agent, the volume density can also be controlled by adjusting the specific surface area, relative density, amount or particle size of the conducting agent.

Further, less particle agglomeration of the particles that form the positive electrode active material layer 12 is likely to result in smaller thickness of the positive electrode active material layer 12 when the positive electrode active material layer 12 is pressed, which tends to result in a higher volume density. In addition, less particle aggregation is likely to improve dispersibility, so that good conductive paths can be formed in the positive electrode active material layer 12, thereby improving the rate performance.

### <Method for Producing Positive Electrode>

The present embodiment's method for producing the positive electrode 1 includes a composition preparation step of preparing a positive electrode composition containing a positive electrode active material, and a coating step of coating the positive electrode composition on the positive electrode current collector 11.

For example, the positive electrode 1 can be produced by applying the positive electrode composition containing a positive electrode active material and a solvent onto the positive electrode current collector 11, followed by drying to remove the solvent to form the positive electrode active material layer 12. The positive electrode composition may contain a conducting agent. The positive electrode composition may contain a binder. The positive electrode composition may contain a dispersant.

The thickness of the positive electrode active material layer 12 can be adjusted by a method in which a layered body composed of the positive electrode current collector 11 and the positive electrode active material layer 12 formed thereon is placed between two flat plate jigs and, then, uniformly pressurized in the thickness direction of this layered body. For this purpose, for example, a method of pressurizing using a roll press can be used.

The solvent for the positive electrode composition is preferably a non-aqueous solvent. Examples of the solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination. With respect to these solvents, a single type thereof may be used individually or two or more types thereof may be used in combination.

### <Non-Aqueous Electrolyte Secondary Battery>

The non-aqueous electrolyte secondary battery 10 of the present embodiment shown in FIG. 2 includes a positive electrode 1 of the present embodiment, a negative electrode 3, and a non-aqueous electrolyte. The non-aqueous electrolyte secondary battery 10 may further include a separator 2. Reference numeral 5 in FIG. 1 denotes an outer casing.

In the present embodiment, the positive electrode 1 has a plate-shaped positive electrode current collector 11 and positive electrode active material layers 12 provided on both surfaces thereof. The positive electrode active material layer 12 is present on a part of each surface of the positive electrode current collector 11. The edge of the surface of the positive electrode current collector 11 is an exposed section 13 of the positive electrode current collector, which is free of the positive electrode active material layer 12. A terminal tab (not shown) is electrically connected to an arbitrary portion of the exposed section 13 of the positive electrode current collector.

The negative electrode 3 has a plate-shaped negative electrode current collector 31 and negative electrode active material layers 32 provided on both surfaces thereof. The negative electrode active material layer 32 is present on a part of each surface of the negative electrode current collector 31. The edge of the surface of the negative electrode current collector 31 is an exposed section 33 of the negative electrode current collector, which is free of the negative electrode active material layer 32. A terminal tab (not shown) is electrically connected to an arbitrary portion of the exposed section 33 of the negative electrode current collector.

The shapes of the positive electrode 1, the negative electrode 3 and the separator 2 are not particularly limited. For example, each of these may have a rectangular shape in a plan view.

With regard to the production of the non-aqueous electrolyte secondary battery 10 of the present embodiment, for example, the production can be implemented by a method in which the positive electrode 1 and the negative electrode 3 are alternately interleaved through the separator 2 to produce an electrode layered body, which is then packed into an outer casing 5 such as an aluminum laminate bag, and a non-aqueous electrolyte is injected into the outer casing, followed by sealing the outer casing 5.

FIG. 2 shows a representative example of a structure of the battery in which the negative electrode, the separator, the positive electrode, the separator, and the negative electrode are stacked in this order, but the number of electrodes can be altered as appropriate. The number of the positive electrode 1 may be one or more, and any number of positive electrodes 1 can be used depending on a desired battery capacity. The number of each of the negative electrode 3 and the separator 2 is larger by one sheet than the number of the positive electrode 1, and these are stacked so that the negative electrode 3 is located at the outermost layer.

### [Negative Electrode]

The negative electrode active material layer 32 includes a negative electrode active material. Further, the negative electrode active material layer 32 may further include a binder. Furthermore, the negative electrode active material layer 32 may include a conducting agent as well. The shape of the negative electrode active material is preferably particulate.

For example, the negative electrode 3 can be produced by a method in which a negative electrode composition containing a negative electrode active material, a binder and a solvent is prepared, and coated on the negative electrode current collector 31, followed by drying to remove the solvent to thereby form a negative electrode active material layer 32. The negative electrode composition may contain a conducting agent.

Examples of the negative electrode active material and the conducting agent include carbon materials such as natural graphite and artificial graphite, lithium titanate, silicon, silicon monoxide, and silicon oxides. Examples of the carbon materials include graphite, graphene, hard carbon, Ketjen black, acetylene black, and carbon nanotube. With respect to each of the negative electrode active material and the conducting agent, a single type thereof may be used alone or two or more types thereof may be used in combination.

Examples of the material of the negative electrode current collector 31 include those listed above as examples of the material of the positive electrode current collector 11.

Examples of the binder in the negative electrode composition include polyacrylic acid, lithium polyacrylate, polyvinylidene fluoride, polyvinylidene fluoride-propylene hexafluoride copolymer, styrene-butadiene rubber, polyvinyl alcohol, polyethylene oxide, polyethylene glycol, carboxymethyl cellulose, polyacrylonitrile, polyimide, and the like. With respect to the binder, a single type thereof may be used alone or two or more types thereof may be used in combination.

Examples of the solvent in the negative electrode composition include water and organic solvents. Examples of the organic solvent include alcohols such as methanol, ethanol, 1-propanol and 2-propanol; chain or cyclic amides such as N-methylpyrrolidone and N,N-dimethylformamide; and ketones such as acetone. With respect to these solvents, a single type thereof may be used individually or two or more types thereof may be used in combination.

The sum of the amount of the negative electrode active material and the amount of the conducting agent relative to the total mass of the negative electrode active material layer 32 is preferably 80.0 to 99.9% by mass, and more preferably 85.0 to 98.0% by mass.

### [Separator]

The separator 2 is disposed between the negative electrode 3 and the positive electrode 1 to prevent a short circuit or the like. The separator 2 may retain a non-aqueous electrolyte described below.

The separator 2 is not particularly limited, and examples thereof include a porous polymer film, a non-woven fabric, and glass fiber.

An insulating layer may be provided on one or both surfaces of the separator 2. The insulating layer is preferably a layer having a porous structure in which insulating fine particles are bonded with a binder for an insulating layer.

The thickness of the separator 2 is, for example, 5 to 50 μm.

The separator 2 may contain at least one of plasticizers, antioxidants, and flame retardants.

Examples of the antioxidant include phenolic antioxidants such as hinderedphenolic antioxidants, monophenolic antioxidants, bisphenolic antioxidants, and polyphenolic antioxidants; hinderedamine antioxidants; phosphorus antioxidants; sulfur antioxidants; benzotriazole antioxidants; benzophenone antioxidants; triazine antioxidants; and salicylate antioxidants. Among these, phenolic antioxidants and phosphorus antioxidants are preferable.

### [Non-Aqueous Electrolyte]

The non-aqueous electrolyte fills the space between the positive electrode 1 and the negative electrode 3. For example, any of known non-aqueous electrolytes used in lithium ion secondary batteries, electric double layer capacitors and the like can be used. The non-aqueous electrolyte used in the manufacture of the non-aqueous electrolyte secondary battery 10 contains an organic solvent, an electrolyte, and an additive.

After manufacture, that is, after initial charging, the non-aqueous electrolyte secondary battery 10 contains an organic solvent and an electrolyte, and may further contain residues or traces derived from the additives.

The organic solvent is preferably one having tolerance to high voltage. Examples of the organic solvent include polar solvents such as ethylene carbonate, propylene carbonate, dimethyl carbonate, diethyl carbonate, ethyl methyl carbonate, γ-butyrolactone, sulfolane, dimethyl sulfoxide, acetonitrile, dimethylformamide, dimethylacetamide, 1,2-dimethoxyethane, 1,2-diethoxyethane, tetrahydrofuran, 2-methyltetrahydrofuran, dioxolane, and methyl acetate, as well as mixtures of two or more of these polar solvents.

The electrolyte is not particularly limited, and examples thereof include lithium-containing salts such as lithium perchlorate, lithium hexafluorophosphate, lithium tetrafluoroborate, hexafluoroarsenate, lithium trifluoroacetate, lithium bis(fluorosulfonyl)imide, and lithium bis(trifluoromethanesulfonyl)imide, or mixtures of two or more of these salts.

The non-aqueous electrolyte secondary battery of the present embodiment can be used as a lithium ion secondary battery for various purposes such as industrial use, consumer use, automobile use, and residential use.

The application of the non-aqueous electrolyte secondary battery of this embodiment is not particularly limited. For example, the battery can be used in a battery module configured by connecting a plurality of non-aqueous electrolyte secondary batteries in series or in parallel, a battery system including a plurality of electrically connected battery modules and a battery control system, and the like.

Examples of the battery system include battery packs, stationary storage battery systems, automobile power storage battery systems, automobile auxiliary storage battery systems, emergency power storage battery systems, and the like.

### EXAMPLES

Hereinbelow, the present invention will be described with reference to Examples and Comparative Examples; however, the present invention should not be construed as being limited to these Examples.

### <Measuring Method>

### [Method for Measuring Z-Average Molecular Weight (Mz) of Binder]

The Z-average molecular weight (Mz) of the binder was measured using the method described above. The devices and measurement conditions used are as follows.
Device name: Agilent 1200 series
Column: Agilent MIXED-B (two-column set)
Column temperature: 40° C.
Mobile phase: N,N-dimethylformamide (containing 10 mM LiBr)
Injection volume: 100 μL
Molecular weight standard: polystyrene
Detector: RI detector

### [Method for Measuring Pore Specific Surface Area and Average Pore Diameter (D50) of Positive Electrode Active Material Layer]

Using a pore size distribution measuring device (product name: Autopore V9620, manufactured by Micromeritics Instrument Corp.), a pretreated sample was placed in a measurement cell and the pore size distribution was measured under the conditions described below. The pore specific surface area and average pore diameter (D50) were calculated based on the obtained pore size distribution.

The pore specific surface area was calculated as the pore surface area per unit mass of the remainder (positive electrode active material layer 12) after removing the positive electrode current collector 11 from the sample (unit: m²/g).

The average pore diameter (D50) was calculated as the median diameter (unit: μm) in the pore size distribution range of 0.003 to 1.000 μm.

### (Measurement Conditions)

Sample pretreatment: A positive electrode sheet was vacuum dried at 110° C. for 12 hours, and then cut into strips each weighing approximately 1.6 g and having a size of approximately 25 mm×12.5 mm.

Measurement cell volume: 5 mL.

Initial pressure: 7.3 kPa.

Mercury parameters: mercury contact angle 130.0°, mercury surface tension 485.0 dyn/cm.

### [Method for Measuring Peel Strength of Positive Electrode Active Material Layer]

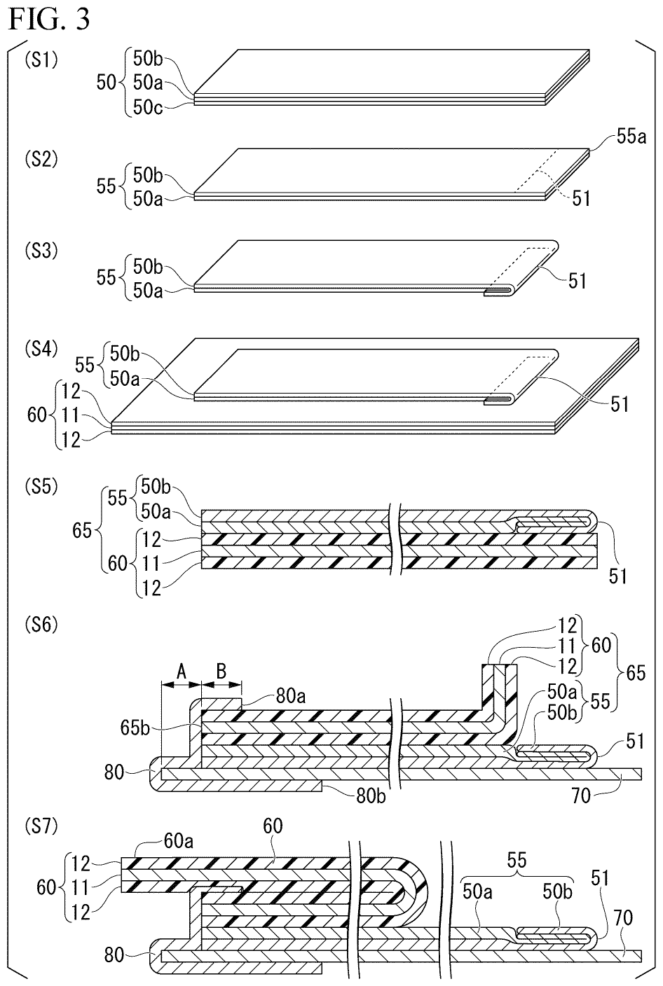

The peel strength of the positive electrode active material layer 12 can be measured by the following method using a tensile tester. FIG. 3 is a process diagram showing a method for measuring the peel strength of the positive electrode active material layer. The steps (S1) to (S7) shown in FIG. 3 are respectively described below. FIG. 3 is a schematic diagram for facilitating the understanding of the configuration, and the dimensional ratios and the like of each component do not necessarily represent the actual ones.
(S1) First, a rectangular double-sided tape 50 having a width of 25 mm and a length of 120 mm is prepared. In the double-sided tape 50, release papers 50b and 50c are laminated on both sides of the adhesive layer 50a. As the double-sided tape 50, a product manufactured and sold by Nitto Denko Corporation with a product name “No. 5015, 25 mm width” is used.
(S2) The release paper 50c on one side of the double-sided tape 50 is peeled off to obtain an adhesive body 55 with the surface of the adhesive layer 50a (hereinafter, also referred to as “glue surface”) being exposed. In the adhesive body 55, a bending position 51 is provided at a distance of about 10 mm from one end 55a in the longitudinal direction of the adhesive body 55.
(S3) The adhesive body 55 is bent at a position on the one end 55a side as viewed from the bending position 51 such that the glue surfaces adhere to each other.
(S4) The adhesive body 55 and the positive electrode sheet 60 are bonded together such that the glue surface of the adhesive body 55 and the positive electrode active material layer 12 of the positive electrode sheet 60 are in contact with each other.
(S5) The positive electrode sheet 60 is cut out along the outer edge of the adhesive body 55, and the adhesive body 55 and the positive electrode sheet 60 are crimped to obtain a composite 65 by a method of reciprocating a crimping roller twice in the longitudinal direction.
(S6) The outer surface of the composite 65 on the adhesive body 55 side is brought into contact with one surface of a stainless plate 70, and the other end 65b on the side opposite to the bending position 51 is fixed to the stainless plate 70 with a mending tape 80. As the mending tape 80, a product manufactured and sold by 3M Company with a product name “Scotch Tape Mending Tape 18 mm×30 Small Rolls 810-1-18D” is used. The length of the mending tape 80 is about 30 mm, the distance A from an end of the stainless plate 70 to the other end 65b of the composite 65 is about 5 mm, and the distance B from one end 80a of the mending tape 80 to the other end 65b of the composite 65 is 5 mm. The other end 80b of the mending tape 80 is attached to the other surface of the stainless plate 70.
(S7) At the end of the composite 65 on the bending position 51 side, the positive electrode sheet 60 is slowly peeled off from the adhesive 55 in parallel with the longitudinal direction. The end (hereinafter, also referred to as “peeling end”) 60a of the positive electrode sheet 60 that is not fixed by the mending tape 80 is slowly peeled off until it protrudes from the stainless steel plate 70.

Next, the stainless plate 70 to which the composite 65 is fixed is installed on a compact table-top tensile tester “EZ-LX” manufactured by Shimadzu Corporation, the end of the adhesive 55 on the bending position 51 side is fixed, and the peeling end 60a of the positive electrode sheet 60 is pulled in the direction opposite to the bending position 51 (180° direction with respect to the bending position 51) at a test speed of 60 mm/min, a test force of 50,000 mN, and a stroke of 70 mm to measure the peel strength. The average value of the peel strength at a stroke of 20 to 50 mm is taken as the peel strength of the positive electrode active material layer 12.

### <Measuring Method>

### [Gravimetric Energy Density]

The evaluation of the gravimetric energy density was performed according to the following procedures (1) to (3).
(1) A cell was prepared so as to have a rated capacity of 1 Ah, and the weight (unit: kg) of the cell was measured.
(2) In an environment of 25° C., the obtained cell was charged at a constant current rate of 0.2 C (that is, 200 mA) and with a cut-off voltage of 3.6 V, and then charged at a constant voltage with a cut-off current set at 1/10 of the above-mentioned charge current (that is, 20 mA). Then, a 30-minute pause was provided while leaving the cell in the open circuit state.
(3) The cell was discharged at a constant current rate of 0.2 C and with a cut-off voltage of 2.5 V. In this process, the gravimetric energy density (unit: Wh/kg) was calculated by dividing the total discharge power (unit: Wh) measured from the start of discharge to the end of discharge by the cell weight (unit: kg) measured in (1).

### [Cycle Capacity Retention]

The cycle capacity retention was evaluated following the procedures (1) to (7) below.
(1) A non-aqueous electrolyte secondary battery was manufactured so as to have a rated capacity of 1 Ah, and a cycle evaluation was carried out at room temperature (25° C.).
(2) The obtained cell was charged at a constant current rate of 0.2 C (that is, 200 mA) and with a cut-off voltage of 3.6 V, and then charged at a constant voltage with a cut-off current set at 1/10 of the above-mentioned charge current (that is, 20 mA).
(3) The cell was discharged for capacity confirmation at a constant current rate of 0.2 C and with a cut-off voltage of 2.5 V. The discharge capacity at this time was set as the reference capacity, and the reference capacity was set as the current value at 1 C rate (that is, 1,000 mA).
(4) After charging the cell at a constant current at a cell's 3 C rate (that is, 3000 mA) and with a cut-off voltage of 3.8 V, a 10-second pause was provided. From this state, the cell was discharged at 3 C rate and with a cut-off voltage of 2.0 V, and a 10-second pause was provided.
(5) The cycle test of (4) was repeated 3,000 times.
(6) After performing the same charging as in (2), the same capacity confirmation as in (3) was performed.
(7) The discharge capacity in the capacity confirmation measured in (6) was divided by the reference capacity before the cycle test to obtain a capacity retention after 3,000 cycles in terms of percentage (3,000-cycle capacity retention, unit: %).

### Production Example 1: Production of Negative Electrode

100 parts by mass of artificial graphite as a negative electrode active material, 1.5 parts by mass of styrene-butadiene rubber as a binder, 1.5 parts by mass of carboxymethyl cellulose Na as a thickener, and water as a solvent were mixed, to thereby obtain a negative electrode composition having a solid content of 50% by mass.

The obtained negative electrode composition was applied onto both sides of a 8 μm-thick copper foil and vacuum dried at 100° C. Then, the resulting was pressure-pressed under a load of 2 kN to obtain a negative electrode sheet. The obtained negative electrode sheet was punched to obtain a negative electrode.

### Production Example 2: Production of Current Collector Having Current Collector Coating Layer

A slurry was obtained by mixing 100 parts by mass of carbon black, 40 parts by mass of polyvinylidene fluoride as a binder, and N-methylpyrrolidone as a solvent. The amount of N-methyl-2-pyrrolidone used was the amount required for applying the slurry. The obtained slurry was applied to both sides of a 15 μm-thick aluminum foil (that is, positive electrode current collector main body) by a gravure method so as to allow the resulting current collector coating layers after drying (total of layers on both sides) to have a thickness of 2 μm, and dried to remove the solvent, thereby obtaining a positive electrode current collector. The current collector coating layers on both surfaces were formed so as to have the same amount of coating and the same thickness.

### Examples 1 to 5, Comparative Examples 1 to 6

As the positive electrode active material particles, the following three types of lithium iron phosphate particles having an active material coating section (hereinafter, also referred to as “carbon-coated active material”) were used.

Carbon-coated active material (1.2): average particle size 1.2 μm, carbon content 1.5% by mass.

Carbon-coated active material (0.3): carbon content 0.3% by mass, average particle size 0.9 μm.

Carbon-coated active material (1.0): carbon content 1.0% by mass, average particle size 1.2 μm.

Carbon-coated active material (1.5): carbon content 1.5% by mass, average particle size 1.3 μm.

The thickness of the active material coating section of the active material was within the range of 1 to 100 nm.

Carbon black or carbon nanotubes were used as the conducting agent.

Impurities in the carbon black and carbon nanotubes were below the quantification limit, and the carbon content can be considered to be 100% by mass.

Polyvinylidene fluoride was used as a binder.

Polyvinylpyrrolidone was used as a dispersant.

N-methyl-2-pyrrolidone was used as a solvent.

An aluminum foil with a current collector coating layer obtained in Example 2, or a 15 μm-thick aluminum foil without a current collector coating layer was used as a positive electrode collector.

A positive electrode active material layer was formed by the following method. The positive electrode active material particles, the conducting agent, the binder, the dispersant, and N-methyl-2-pyrrolidone as a solvent were mixed in a mixer to obtain a positive electrode composition. The amount of the solvent used was the amount required for applying the positive electrode composition. The amounts of the positive electrode active material particles, conducting agent, binder, and dispersant in the table are percentages when the total amount excluding the solvent is 100% by mass.

The obtained positive electrode composition was applied to both surfaces of the positive electrode current collector, and after pre-drying, the applied composition was vacuum-dried at 120° C. to form positive electrode active material layers. The positive electrode active material layers on both surfaces of the positive electrode current collector were formed so as to have the same coating amount and the same thickness. The obtained laminate was pressure-pressed to obtain a positive electrode sheet.

The obtained positive electrode sheet was punched to obtain a positive electrode.

A non-aqueous electrolyte secondary battery having a configuration shown in FIG. 2 was manufactured by the following method.

Lithium hexafluorophosphate as an electrolyte was dissolved at 1 mol/L in a solvent in which ethylene carbonate (hereinafter referred to as EC) and diethyl carbonate (hereinafter referred to as DEC) were mixed at a volume ratio, EC:DEC, of 3:7, to thereby prepare a non-aqueous electrolytic solution.

As a separator, a polyolefin film having a thickness of 15 μm was used.

The positive electrode obtained in this example and the negative electrode obtained in Production Example 1 were alternately interleaved through a separator to prepare an electrode layered body with its outermost layer being the negative electrode.

In the step of producing the electrode layered body, the separator 2 and the positive electrode 1 were first stacked, and then the negative electrode 3 was stacked on the separator 2.

Terminal tabs were electrically connected to the exposed section 13 of the positive electrode current collector and the exposed section 33 of the negative electrode current collector in the electrode layered body, and the electrode layered body was put between aluminum laminate films while allowing the terminal tabs to protrude to the outside. Then, the resulting was laminate-processed and sealed at three sides.

To the resulting structure, a non-aqueous electrolytic solution was injected from one side left unsealed, and this one side was vacuum-sealed to manufacture a non-aqueous electrolyte secondary battery.

By the above method, the gravimetric energy density and discharge performance were evaluated by a quick charge test. The results are shown in Table 1.

TABLE 1

| | | | | | | Carbon- | | | | |
|---|---|---|---|---|---|---|---|---|---|---|
| | | | | | | coated | | | | |
| | Z | | Pore | Average | | active | | | | Capacity |
| | average | | specific | pore | | material | Conducting | Conductive | Gravimetric | retention |
| | molecular | Binder | surface | diameter | Peel | Carbon | agent | carbon | energy | after 3000 |
| | weight | content | area | (D50) | strength | content | content | content | density | times of |
| | (Mz) | [% by mass] | [m²/g] | [μm] | [mN/cm] | [% by mass] | [% by mass] | [% by mass] | [Wh/kg] | 3 C/3 C cycles |
| Ex. 1 | 760,000 | 0.5 | 7.8 | 0.081 | 213 | 1.5 | 0 | 1.5 | 178 | 87 |
| Ex. 2 | 520,000 | 0.5 | 7.3 | 0.124 | 119 | 1.5 | 0 | 1.5 | 178 | 83 |
| Ex. 3 | 800,000 | 1.3 | 8.1 | 0.073 | 341 | 1.5 | 0 | 1.5 | 173 | 86 |
| Ex. 4 | 780,000 | 0.5 | 7.6 | 0.086 | 297 | 1.0 | 0 | 1.0 | 179 | 79 |
| Ex. 5 | 750,000 | 0.5 | 11.4 | 0.063 | 78 | 1.5 | 1.2 | 2.7 | 171 | 75 |
| Comp. Ex. 1 | 310,000 | 2 | 4.3 | 0.179 | 297 | 1.5 | 0 | 1.5 | 170 | 62 |
| Comp. Ex. 2 | 780,000 | 1.7 | 3.9 | 0.258 | 714 | 1.5 | 0 | 1.5 | 171 | 57 |
| Comp. Ex. 3 | 150,000 | 2 | 4.6 | 0.161 | 74 | 1.5 | 0 | 1.5 | 170 | 58 |
| Comp. Ex. 4 | 920,000 | 0.5 | 13.7 | 0.056 | 120 | 1.5 | 3.5 | 5.0 | 159 | 51 |
| Comp. Ex. 5 | 110,000 | 0.5 | 3.4 | 0.313 | 8 | 1.5 | 0 | 1.5 | 178 | 11 |
| Comp. Ex. 6 | 750,000 | 0.5 | 7.1 | 0.143 | 410 | 0.3 | 0 | 0.3 | 181 | 6 |

As can be seen from the results shown in Table 1, in Example 1, sufficient binding was obtained with a small amount of binder, and both the pore specific surface area of the positive electrode active material layer and the average pore diameter of the pores in the positive electrode active material layer were in the appropriate ranges, so that there were few side reactions with the electrolyte, and the gravimetric energy density and cycle capacity retention rate were excellent.

In Example 2, the Z average molecular weight (Mz) of the binder was small, resulting in slightly less binding of the positive electrode active material layer to the positive electrode current collector, and less peel strength of the positive electrode active material layer. The cycle capacity retention also decreased slightly, but this was considered to be within an acceptable range.

In Example 3, a binder with a small Z average molecular weight (Mz) was used, and the amount of the binder added was slightly increased. As a result, the pore specific surface area of the positive electrode active material layer increased and the average pore diameter of the pores in the positive electrode active material layer decreased. This resulted in slightly increased peel strength of the positive electrode active material layer. Using a binder with a higher Z average molecular weight (Mz) makes it easier to adjust the pore specific surface area of the positive electrode active material layer and the average pore size of the pores in the positive electrode active material layer to appropriate ranges with a smaller amount.

In Example 4, the amount of conductive carbon was small, so that the amount of carbon that does not contribute to the capacity was reduced, resulting in higher gravimetric energy density of the battery. By using a binder with at least a high Z average molecular weight (Mz) of conductive carbon, the binding strength increased, and peeling of the conductive carbon and disconnection of the conductive path due to expansion and contraction during charging and discharging were suppressed, and good cycle performance was shown.

In Example 5, a conducting agent was added to increase the amount of conductive carbon. By using a binder with a high Z average molecular weight (Mz), a high gravimetric energy density and a good capacity retention at high rate cycles were achieved even with the addition of a small amount of conducting agent.

In Comparative Example 1, a larger amount of binder with a smaller Z average molecular weight (Mz) was added, but the pore specific surface area of the positive electrode active material layer was not within an appropriate range, and the contact area between the electrolyte solution and the positive electrode active material layer during the charge/discharge reaction during cycling was insufficient, resulting in high resistance which accelerated degradation.

In Comparative Example 2, too large an amount of binder with a larger Z average molecular weight (Mz) added, so that the pore specific surface area of the positive electrode active material layer was small and the average pore diameter of the pores in the positive electrode active material layer was large, resulting in poor conductive paths and a decrease in cycle capacity retention.

In Comparative Example 3, a binder with a smaller Z average molecular weight (Mz) than in Comparative Example 1 was used, resulting in a lower peel strength of the positive electrode active material layer, an inferior conductive path of the positive electrode due to expansion and contraction during cycling, and a decrease in gravimetric energy density and cycle capacity retention.

In Comparative Example 4, the addition of a large amount of conducting agent increased the pore specific surface area of the positive electrode active material layer, and decreased the average pore diameter of the pores in the positive electrode active material layer. Further, the addition of the conducting agent decreased the gravimetric energy density and cycle capacity retention.

In Comparative Example 5, a binder with a smaller Z average molecular weight (Mz) than in Comparative Example 1 was used, and the amount of binder added was reduced compared to Comparative Example 1. As a result, the peel strength of the positive electrode active material layer was very low, and the gravimetric energy density and cycle capacity retention decreased.

In Comparative Example 6, the amount of conductive carbon was reduced, and it was possible to increase the gravimetric energy density, but the conductive carbon required for a good charge/discharge reaction was insufficient, so that the cycle capacity retention decreased although the electrode had a high Z-average molecular weight (Mz), high binding strength, and high peel strength.

### EXPLANATION OF REFERENCE NUMERALS

1 Positive electrode (positive electrode for non-aqueous electrolyte secondary battery)
2 Separator
3 Negative electrode
5 Outer casing
10 Non-aqueous electrolyte secondary cell
11 Current collector (positive electrode current collector)
12 Positive electrode active material layer
13 Exposed section of positive electrode current collector
14 Positive electrode current collector main body
15 Current collector coating layer
31 Negative electrode current collector
32 Negative electrode active material layer
33 Exposed section of negative electrode current collector
50 Double-sided tape
50 Adhesive layer
50b Release paper
51 Bending position
55 Adhesive body
60 Positive electrode sheet
70 Stainless steel plate
80 Mending tape

1. A positive electrode for a non-aqueous electrolyte secondary battery, comprising a current collector and a positive electrode active material layer provided on the current collector, wherein:
the positive electrode active material layer comprises positive electrode active material particles and a binder,
the binder has a Z-average molecular weight (Mz) of 400,000 or more and 1,400,000 or less,
an amount of the binder is 0.1% by mass or more and 1.5% by mass or less with respect to a total mass of the positive electrode active material layer, and
the positive electrode active material layer comprises a conductive carbon in an amount of 0.5% by mass or more and less than 3.0% by mass or less with respect to a total mass of the positive electrode active material layer.

2. The positive electrode according to claim 1, wherein a peel strength of the positive electrode active material layer relative to the current collector is 10 mN/cm or more and 1000 mN/cm or less.

3. The positive electrode according to claim 1, wherein the positive electrode active material layer is a porous layer, the positive electrode active material layer has a specific pore surface area of 5.0 m²/g or more and 10 m²/g or less, and an average pore diameter (D50) of pores in the positive electrode active material layer is 0.070 μm or more and 0.150 μm or less.

4. The positive electrode according to claim 1, wherein the positive electrode active material particles comprise a compound represented by a formula LiFeₓM₍₁₋ₓ₎PO₄, wherein 0≤x≤1, M is Co, Ni, Mn, Al, Ti or Zr.

5. A non-aqueous electrolyte secondary battery, comprising the positive electrode of claim 1, a negative electrode, and a non-aqueous electrolyte disposed between the positive electrode and the negative electrode.

6. A battery module or battery system comprising a plurality of the non-aqueous electrolyte secondary batteries of claim 5.
